(19) United States
(12) Patent Application Publication
(10) Pub. No.: US 2007/0206086 A1
(43) Pub. Date: Sep. 6, 2007

(54) ON-LINE EXPERT PROVISION SYSTEM AND METHOD

(75) Inventors: Donald L. Baron, Seattle, WA (US); Steven Eugene Koon, Puyallup, WA (US)

Correspondence Address: AXIOS LAW GROUP, 1725 WESTLAKE AVENUE NORTH, SUITE 150, SEATTLE, WA, 98109, US

(73) Assignee: EXPERTICITY, INC., Seattle, WA (US)

(21) Appl. No.: 11/306,958

(22) Filed: Jan. 17, 2006

Related U.S. Application Data
(63) Continuation-in-part of application No. 11/050,372, filed on Feb. 2, 2005.
(60) Provisional application No. 60/643,881, filed on Jan. 14, 2005.

(51) Int. Cl. H04N 7/14

(52) U.S. Cl. 348/14.01

(57) ABSTRACT

A networked system of terminals and servers includes one or more customer terminals, one or more customer service expert terminals and communications links enabling communication between selected ones of the customer and expert terminals. Each of the customer and expert terminals supports two-way transmission of audio, video and other data. A peer-to-peer link is established between the selected customer and expert terminals to facilitate communications. Selected data are sent through a system server. The system thereby enables customers and experts to interact with each other in a natural conversational manner. The system thereby enables businesses and other organizations to provide effective customer support to there customers wherever located, using a customer support staff that need not be physically located at the customer's location.

### RELATED APPLICATIONS

This application is a continuation-in-part of U.S. patent application Ser. No. 11/050,372, entitled SYSTEM AND METHOD FOR PROVIDING LIVE ON-SCREEN VIDEO EMPLOYEES, with the named inventors Donald L. Baron and Steve Koon, filed on Feb. 2, 2005; and claims the benefit of U.S. Provisional Patent Application No. 60/643,881, entitled ON-LINE MARKET PLACE OF IP VIDEO-CONFERENCE SERVICES, with the named inventors Donald L. Baron, Steve Koon and Sonja Price, filed on Jan. 14, 2005; the entireties of which are hereby incorporated by reference.

### FIELD

This invention relates generally to providing expert assistance via interconnected computer terminals and, more particularly, to providing informed assistance to customers at remote locations where and as needed.

### BACKGROUND

The success of any commercial enterprise rests largely on satisfied customers. Regardless of the particular product or service, customer service plays an important role in keeping customers happy. An informed and helpful sales staff, available to assist customers in purchasing selections, plays an important part in achieving this goal. An informed and helpful service staff, available to answer questions, receive complaints, or solve problems related to purchased goods and services, plays another important role. Even a fast and courteous checkout staff available to complete the transaction and send the customer on his or her way quickly and expeditiously contributes greatly to an overall favorable customer experience. As products become more and more complex, and as competition for customers becomes ever tighter, the role of customer service becomes ever more important. No longer is it sufficient merely to provide a quality product at a fair price. Customers expect and deserve to receive a pleasant and satisfying shopping experience as well.

Although the importance of an effective customer service staff cannot be denied, actually maintaining one is full of difficulties. Considerable training and experience are often needed before a customer representative is effective in assisting customers with their purchasing decisions. Furthermore, people with the right mixture of experience, product knowledge and customer interactive skills can be hard to find and expensive to retain. In addition, there is the problem that customer demands do not remain constant during the business day but tend to peak and ebb at various times during the day. A customer service staff adequate to handle peak customer volumes will often be greatly underutilized at off-peak hours. Alternatively, a customer service staff adequate only for off-peak hours will be greatly overloaded during peaks. Long lines, unanswered questions, frustrated customers and a generally unsatisfactory purchasing experience can be the result. Finally, such problems do not stem solely from variations in demand during the business day. They can result from geography as well. For example, even though the overall demand for certain products and services is likely to be greater in large metropolitan areas than in smaller markets, the need for knowledgeable customer service people in smaller markets nevertheless exists. Businesses having a national scope find it advantageous, therefore, to make experienced and knowledgeable customer service staff available to customers in smaller markets as well as large. The cost of doing so, however, can be difficult to justify when such experience and knowledge are only needed occasionally.

In addition to new developments in customer relations, communications between electronic devices have also improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

In some scenarios, customers may desire to speak with experts on a variety of topics and at a variety of locations, possibly outside commercial establishments and on topics outside the scope of a particular establishment. Current customer service systems used to connect a customer with an expert at a place and time of their choosing have a number of drawbacks.

Using a conventional telephone service, customers and experts are limited to voice communications and it is difficult to present images and/or video data. Additionally phones are generally unable to provide the same level of communications that a live video connection is able to provide.

Another form of communication between a customer and an expert is simply to have the customer visit the expert at a physical location or vice versa. This has the drawback in that customers are only able to travel to meet with those experts there that are within a feasible distance for the customer to contact. Additionally for the experts, they are limited to assisting only those customers who can reach them.

Some attempts have been made to provide expert assistance online, however these attempts have generally been limited to text-based instant messaging and/or telephone call backs, both of which have at least the limitations described above with regard to conventional telephone communications.

Furthermore all the above expert interaction methods have a drawback that customers are not able to choose which experts they wish to communicate with before establishing the communications. Generally, a customer is arbitrarily routed to an expert without the customer being able to examine or verify the expert's qualifications. Additionally in some scenarios, a customer may want a record of their expert session and conventional online expert communications do not provide a ready mechanism for preserving expert to customer communications, in particular the visual aspects of any expert communications.

### DRAWINGS

Embodiments of the invention, may be understood by reference to the following description taken in conjunction with the accompanying drawings, wherein like reference numerals identify like elements and wherein:

FIG. 1 is a simplified system diagram showing one embodiment of a live, on-line video expert system embodying various features of one embodiment.

FIG. 2 is a simplified diagram of a terminal usable as both a customer terminal and as an expert terminal in one embodiment of the live, on-line video expert system shown in FIG. 1.

FIGS. 3a-3k are exemplary figures depicting operations of the system in the context of a car rental transaction, useful in understanding the operation and capability of the system shown in FIGS. 1-2.

FIG. 4 is a representative sample of a customer/expert user interface screen useful in understanding the operation and capability of the system shown in FIGS. 1-3.

FIG. 5 is a flow diagram illustrating an exemplary sign-up routine suitable for use in a variety of embodiments.

FIG. 6 is a flow diagram illustrating an exemplary login routine suitable for use in a variety of embodiments.

FIG. 7 is a flow diagram illustrating an exemplary expert session routine suitable for use in a variety of embodiments.

FIG. 8 is a flow diagram illustrating an exemplary session creation subroutine suitable for use in a variety of embodiments.

FIG. 9 is a flow diagram illustrating an exemplary session scheduling routine suitable for use in a variety of embodiments.

FIGS. 10-19 illustrate a variety of exemplary customer screenshots suitable for use in a variety of embodiments.

FIGS. 20-23 illustrate a variety of exemplary expert screenshots suitable for use in a variety of embodiments.

### DETAILED DESCRIPTION

The detailed description that follows is represented largely In terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices or combinations of illustrated devices, may be added to or combined without limiting the scope to the embodiments disclosed herein.

Exemplary embodiments provide a system for providing real-time interaction between a human customer and a human expert in a commercial transaction setting wherein the human customer and human expert are not in each other's physical presence. The system includes a customer terminal operable to transmit and receive video, audio and data communications. The system further includes an expert terminal operable to transmit and receive video, audio and data communications. The system also includes a network for establishing a peer-to-peer connection between the customer terminal and the expert terminal so that video, audio and data information can be passed in real-time between the customer and the expert through the customer terminal and the expert terminal.

Further embodiments also provide a method of providing human interaction between a customer and an expert who are not in each other's physical presence. The method includes the steps of providing a customer terminal operable to transmit and receive video, audio and data communications, and providing an expert terminal operable to transmit and receive video, audio and data communications. The method further includes the step of establishing a peer-to-peer connection between the customer terminal and the expert terminal so that video, audio and data information can be passed in real-time between the customer and the expert through the customer terminal and the expert terminal

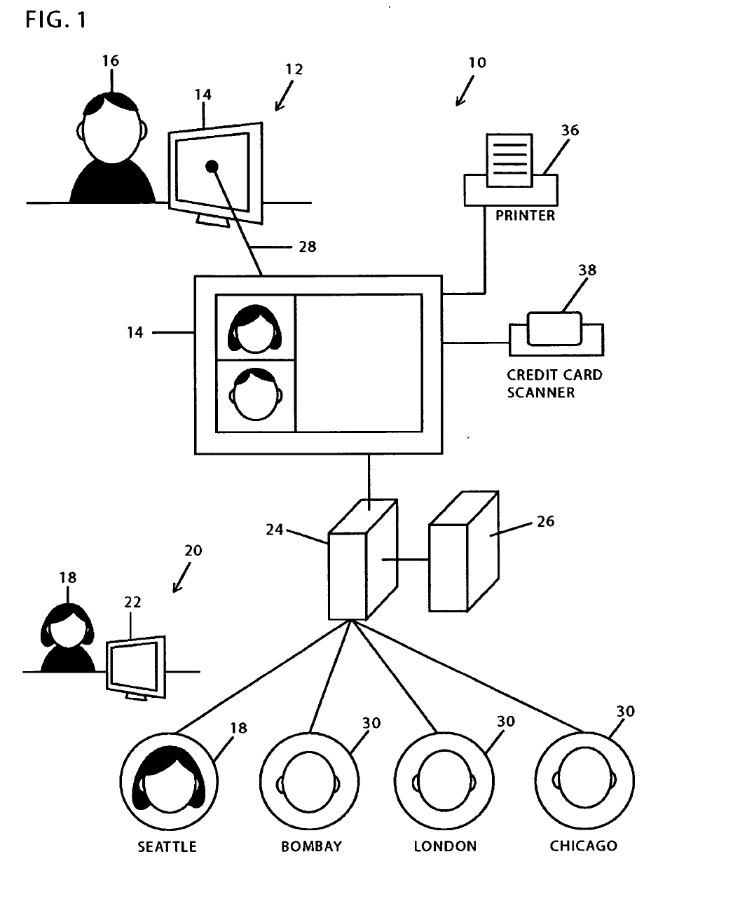

Referring to FIG. 1, a live on-screen video expert system 10 is shown. As depicted, and for purposes of example only, part of the system 10 may be located at the point of service 12 of a business, such as a car rental agency, located at an airport or other facility. It will be understood that this is only for purposes of example and is not meant to be limiting.

The expert system 10 may be used wherever it is desired that customers be able to interact with live customer service personnel or experts in a real-time basis. The system 10 can be used, for example, in a retail sales outlet, such as a department store or sales mall, where customers often need assistance with their purchasing decisions. The system 10 can also be used in other facilities, such as banks or government offices, where customers need to interact with others to complete their transactions. In some embodiments, part of the system 10 may be at a customer's residence, or at some other location of a customer's choosing. The system 10 is particularly useful where the customer and expert are not in each other's physical presence, yet it is important that they be able to interact as if they were.

As illustrated in FIG. 1, the system 10 includes a user interface for one or more customers located at the point of service 12. In the illustrated embodiment, the user interface for customers takes the form of one or more individual customer video terminals 14 accessible by one or more customers 16. The system 10 further Includes a user interface for one or more experts 18 located at a remote location 20, such as a call center or separate service branch. In the illustrated embodiment, the user interface for the customer service experts takes the form of one or more individual expert video terminals 22. The system 10 further includes structure for providing connectivity between the customer and expert terminals as well as connectivity with databases maintained by the business or service provider where the system 10 is installed. In the illustrated embodiment, such connectivity is provided in part by means of a system server 24 and a client back end server 26 coupled to each other and to the customer and expert terminals 14, 22 through a network 28.

Further connectivity is provided by means of peer-to-peer connections established between the customer terminals and the expert terminals. Establishing peer-to-peer connections between individual customer terminals and expert terminals enhances communications between such terminals by avoiding the bandwidth, speed and scalability limitations that can result when a video server is provided.

In one embodiment, the customer and expert terminals 14, 22, as well as the system and client back end servers 24, 26 are interconnected through a high speed IP or 3G network (such as the Internet). Alternatively, the interconnection could be via a direct connection, a dialup connection, an intranetwork, or by a combination of the foregoing. Still various other network configurations and topologies can be used in alternate embodiments.

The customer terminals (also know as customer devices) 14 are, in one embodiment, clustered in a point of service area 12 as shown. Alternatively, they can be placed at various locations throughout a store or other facility. It will be appreciated that, if desired, several customer service counters 12 can be located in a particular store or facility. The expert terminals 22 can be similarly clustered in a call center or separate service branch. Alternatively, the expert terminals 22 can be located at disparate locations within a facility, or even in different cities and countries.

In the illustrated embodiment, several expert video terminals are provided at various locations 30 throughout the world. Each can be staffed by a different expert. In one embodiment, each expert terminal is located at the desk or workstation of an individual customer service representative or expert.

Experts may be customer service representatives, or in some embodiments, they may be other individuals who offer their skills and/or knowledge to customers using the system 10.

The system and client back end servers 24, 26 can also be located remotely from both each other and from the customer and expert terminals 14, 22. The system server 24 provides many of the control and system functions (to be described below) associated with system operation. The client server 26 handles the various functions (e.g., inventory control, sales transactions, customer information, etc.) associated with the various business functions of the store or facility. In further embodiments, the system and client servers 24, 26 may have different and/or additional functions. For example, the client server 26 may also act as a video server/video reflector to connect a plurality of customer devices 14 to an expert terminal 22.

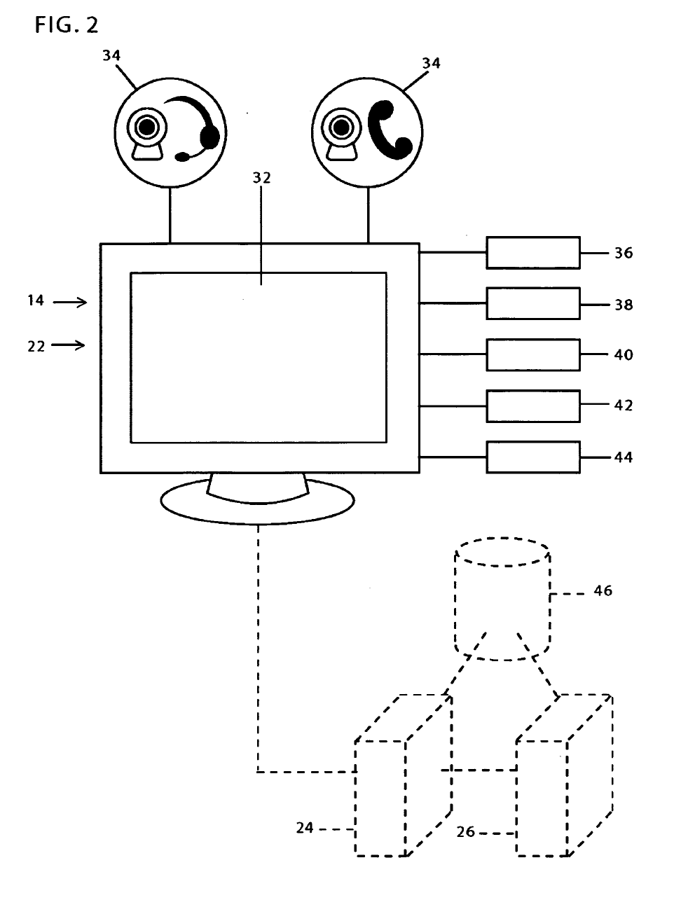

Referring to FIG. 2, each of the customer and expert terminals 14, 22 provides a platform for exchanging video, audio and data information in real-time in both directions. In one embodiment, each terminal comprises a PC-based transmitting and receiving platform such as personal computers, laptop computers, Tablet PCs, handheld devices or other known devices. In one embodiment, they are wireless devices, although hard-wired devices can be used. As illustrated, each customer and expert terminal may include a video display screen 32, multimedia peripherals (e.g., microphone, speaker, camera and the like) 34 for communicating audio and video to and from the customer, and a plurality of peripheral devices for facilitating interaction between the customer and expert. Such peripheral devices may include a printer 36 and a credit card scanner 38 for completing a purchase or other transaction. Additional peripheral devices can be provided including an RFID detector 40, a bar code scanner 42 and various forms of biometric security or measuring devices 44 to permit verification of a customer's identity.

Each of the customer and expert terminals 14, 22 may include associated memory 46 wherein data can be stored and accessed. Such data can relate to information, such as product specifications, helpful to customers and can be accessed by the service expert for display on the customer terminal. Such data can also relate to information (e.g., the nature of the assistance rendered and how long each customer transaction took, whether a sale actually resulted, etc.,) that, while not needed for the transaction itself, can nevertheless be helpful to the business in tracking its costs and improving its service. Such data can also include information concerning each transaction itself, such as when it took place, what items were purchased and for how much, etc. Although the memory 46 can be contained in each terminal, it may also be maintained as part of the system server 24 or client back end server 26 or both.

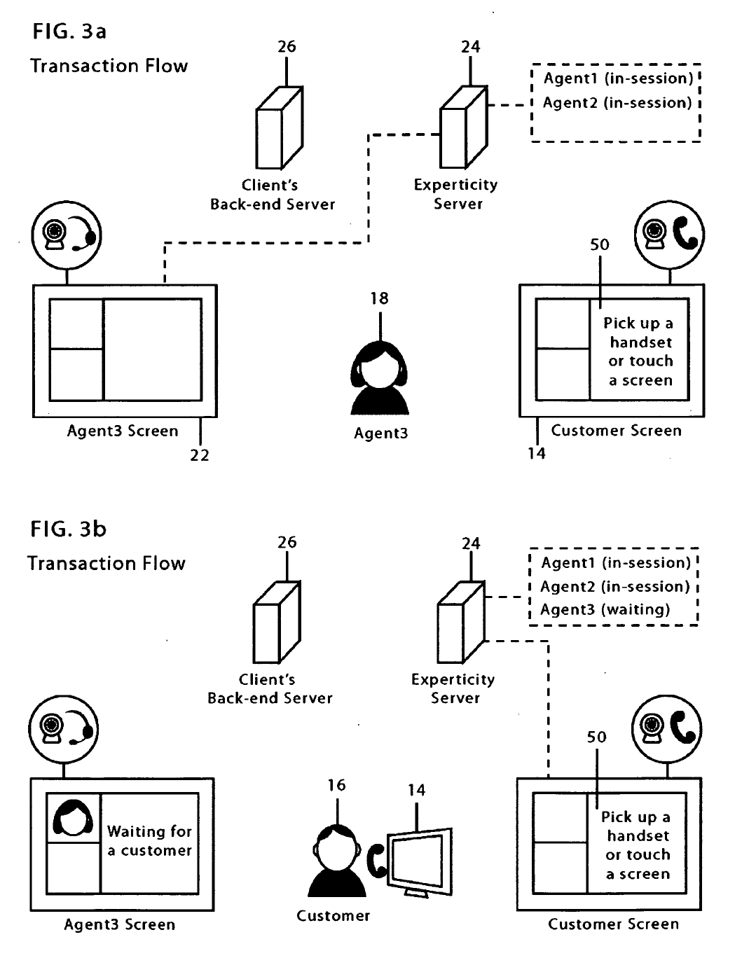

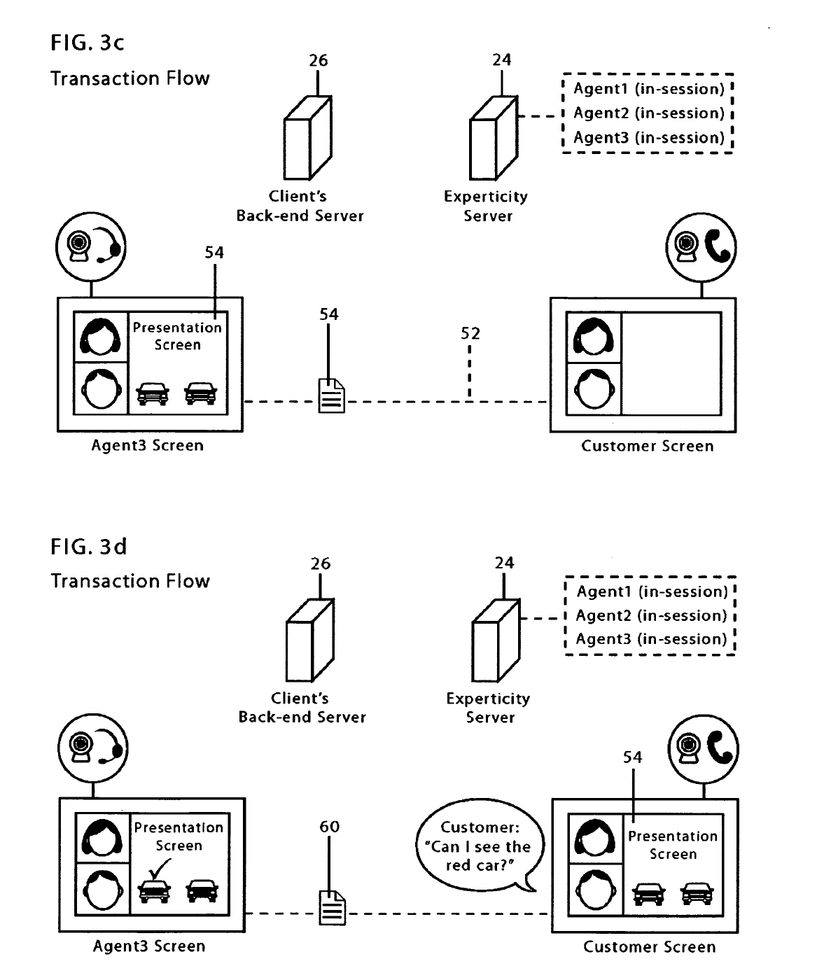

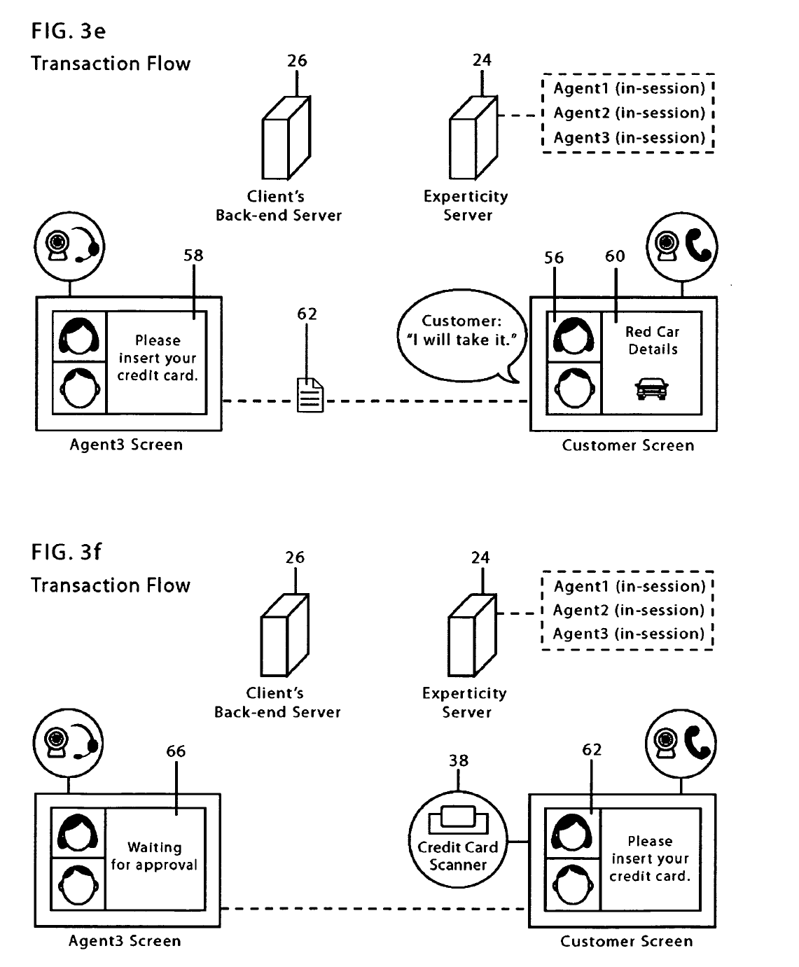

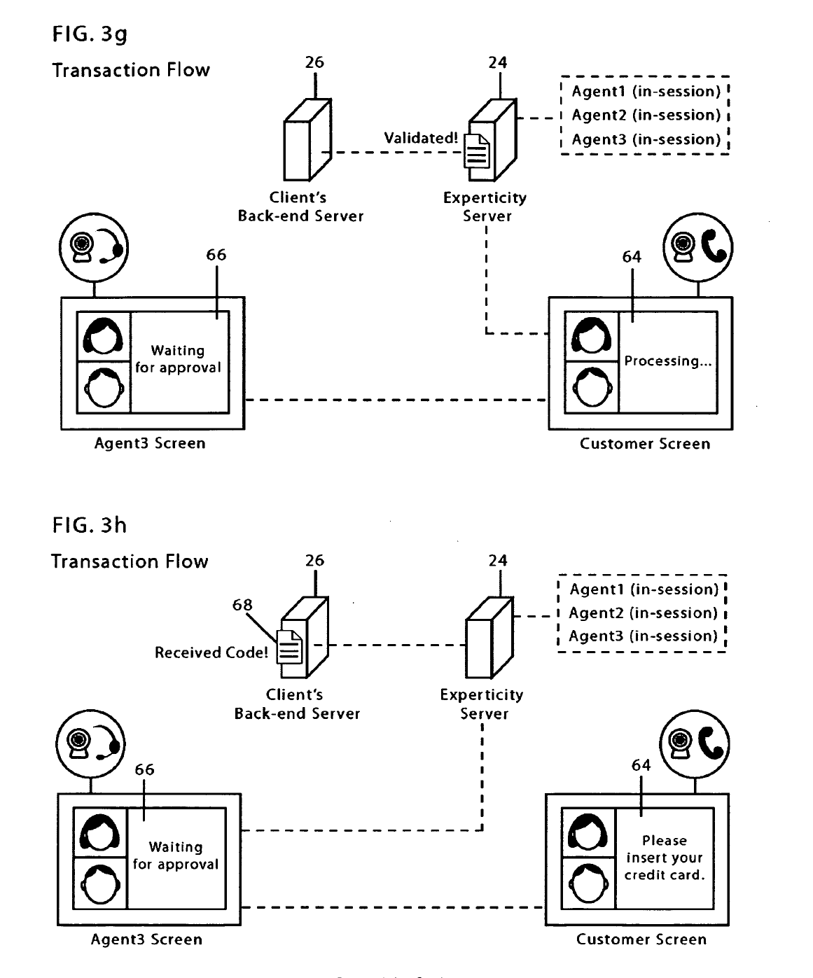

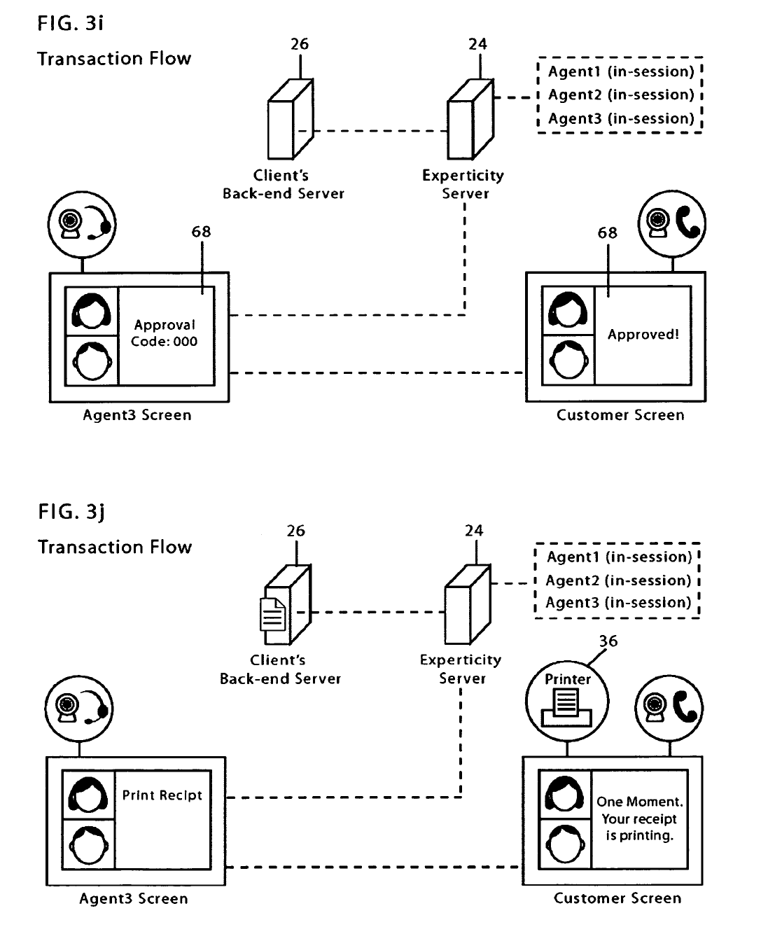

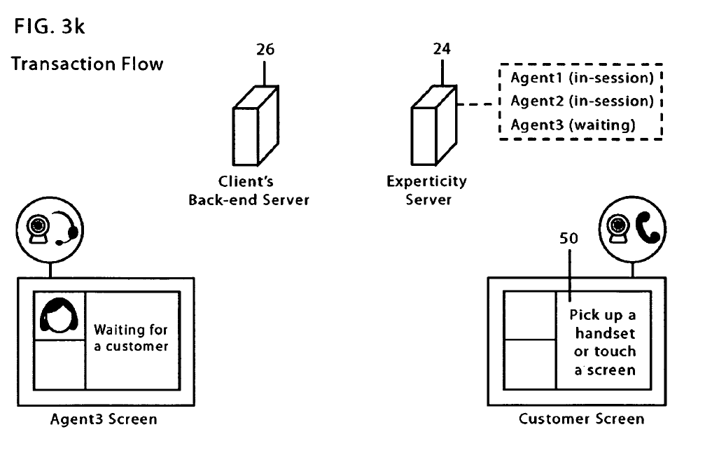

In operation, a customer 16 needing assistance can use an available terminal 14 to request and receive help. An illustrative session, useful for understanding the function and operation of the live on-screen video expert system 10, is shown in FIGS. 3a-3k. In the illustrated embodiment, the system 10 is being provided by a car rental business wherein the customer 16 may be located at an airport or other location, while the customer service expert 18 is located at a different location. It will be appreciated that while the particular embodiment is shown and described in the context of a car rental business, this is done for illustrative purposes only, and it will be appreciated that various embodiments have use in a wide variety of other applications as well.

As shown in FIG. 3a, the expert 18, who has perhaps just begun her workday or just finished assisting a customer, indicates that she is available to assist others by logging into a call queue and awaiting a call. She may do this by entering an appropriate command on her expert terminal 22. The expert terminal then signals the system server 24 that the expert is available. In the illustrated example, the system server 24 recognizes that two of the other available experts are already busy helping others but that this expert is free.

In FIG. 3b, a customer 16 needing assistance approaches one of the customer terminals 14 and picks up a handset or touches the screen, thereby triggering a request for an expert. In one embodiment, customer instructions 50 (e.g., “Pick up a handset or touch a screen”) appear as a default screen on each customer terminal 14 during idle periods. The request is then sent from the customer terminal 14 to the system server 24. In the discussion that follows, whatever currently appears on the screen of the customer terminal 14 is referred to as the “presentation screen.” In one embodiment, the presentation screen also appears on the expert's screen so that the expert and customer both see the same display at the same.

Upon receiving the request, a peer-to-peer session 52 is established between the customer terminal and the expert terminal as shown in FIG. 3c. The expert may push out an initial presentation screen 54 to the customer terminal on the established peer-to-peer link 52. The initial presentation screen 54 is then displayed on the customer terminal 14. In addition, a video link and audio link are established between the customer and expert terminals. In the illustrated embodiment, a real-time video image 56 of the expert 18 is displayed on the screen of the customer terminal, while a real-time video image of the customer 16 is displayed on the screen of the expert. In one embodiment, both images appear on each screen. In other embodiments, it may be desirable for only the image of the expert to appear on the customer terminal (and only the customer to appear on the expert's terminal). By establishing a real-time video and audio link between the customer terminal 14 and expert terminal 22, the customer 16 and expert 18 are able to interact in a natural, conversational manner, much as they would were they actually face-to-face in each other's presence.

In FIG. 3d and 3e, the customer requests details about a particular product. This is done by the customer speaking to the expert in a normal, conversational manner. The expert then sends information 60 about the product to the customer for display on the customer terminal video screen. The customer reviews information about the product and makes a purchasing decision. During this time, the customer can ask the expert questions about the product or request additional information about the product or alternatives. The expert can send information about other products to the customer if desired. Eventually, the customer makes a decision to buy and communicates that decision to the expert.

The expert then asks the customer to insert a credit card into the card reader and awaits an approval code (FIG. 3f). At the same time, the expert terminal sends an appropriate screen 62 to the customer's video display requesting the credit card information and instructing the customer how to provide it (screen 58). Using the credit card reader 38, the customer provides the requested information, which is then sent by the customer terminal to the system server 24. The system server 24 pre-validates the credit card and forwards the information to the client back end server 26 for approval. During this time, the customer sees a screen 64 indicating that the system is processing the credit card, while the expert 18 receives a screen 66 indicating that the system is waiting for approval.

In FIG. 3h, the client back end server 26 receives the pre-validated credit card information and approves the transaction. An appropriate approval message 68 is generated and returned to the system server 24 that in turn returns an appropriate approval code to the expert terminal (FIG. 3i). The approval code 68 is displayed on the expert terminal video screen thereby signaling the expert that the credit card has been approved and that the transaction can proceed.

Upon receiving the approval code, the expert tells the customer that the transaction is complete and that a receipt is being sent (FIG. 3j). A screen 70 indicating the same is sent from the expert terminal 22 for display on the customer terminal 14. The receipt is printed on the printer 36 associated with the customer terminal and can be retained by the customer. Once the receipt is printed, the customer takes the receipt and leaves the area. The initial default screen 50 is then displayed on the customer terminal 14, and the expert 18 once again signals to the system server 24 that she is available to help the next customer (FIG. 3k).

During the session, various data can be collected and stored in the memory 46 for future use and analysis.

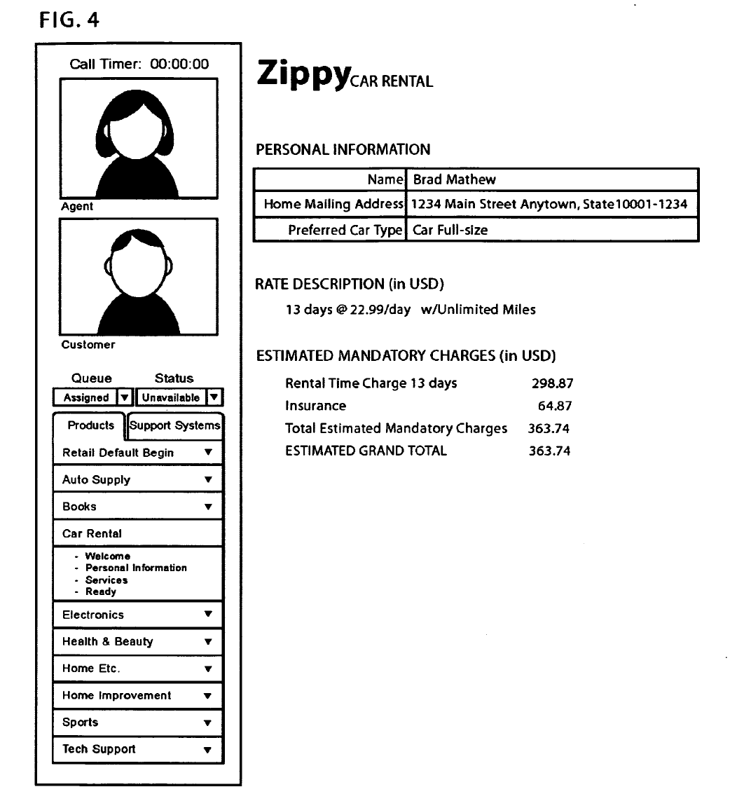

An illustrative example of an expert/customer interface screen is shown in FIG. 4. As shown, the interface includes audio/video display modules through which images of the customer and expert appear. Although the expert terminal 22 may include both modules, it may be optional whether to make an image of the customer available on the customer terminal 14. In one embodiment, the expert's name is displayed as part of the expert video module. The customer's location and other information concerning the customer (if desired) are displayed to the expert as well. The date and time are displayed. A video sizing or “zoom” control allows the expert to control the size of the video image on the customer terminal. Volume controls are provided for both the customer and expert. A call timer records the time that the expert is in the current call session, and a record feature enables the expert or supervisor to record the session.

As further illustrated, a status control enables the expert to indicate to the system the expert's current status. By using the control, the expert can indicate to the system that the expert is available to take a call, is on a break or in a meeting or is otherwise unavailable.

The expert interface screen further includes a prompter guide window that displays text scripts that are to be read by the expert. In one embodiment, the prompter guide window is capable of displaying any content that can be displayed within a Web browser, such as HTML, Word Documents, Adobe PDFs and video files. Additionally, a prompter window may request that the expert click “accept,” thereby indicating that the expert has read the script, before allowing the transaction to proceed. This can be used to provide a desired corporate message to each customer as well as ensure compliance with company policies and applicable law. A field is provided where the expert can record notes during the transaction.

Still further features (not shown) may be provided to assist the expert 18 in using the system 10. A list of technical “frequently asked questions” enables the expert to find help for common questions or problems. A supervisor contact control enables the expert to contact a supervisor through e-mail or instant messaging if needed. A navigation tab enables the expert to access the organization's information system for further information regarding products, services, etc. A support system control provides the expert with access to the organization's back-end systems without having to leave the interface with the customer.

A presentation window is also provided that enables the expert to view information or other content and display it to the customer. This includes a search bar that allows the expert to run text searches from content descriptions and a navigation control that allows the expert to manipulate the presentation window as viewed by the customer. A Back/Forward function operates the same as the “Back” and “Forward” buttons in a browser, while “Pause” and “Stop” buttons pause or stop, respectively, animated presentations. A “Home” button returns the presentation to the customer terminal default page, while a “Print” button sends the current presentation to the printer at the customer terminal. Finally, a “Full Screen” button allows the expert to run the presentation window on the customer terminal screen in a full-screen mode. Likewise, the customer can review other content available at their terminal 14, in addition to any information provided by the expert. Furthermore in some embodiments, the customer may be able to send the expert material from the customer terminal 14.

An expert-side Web-Browsing feature permits the expert to browse Internet sites in a window outside the presentation window and out of view of the customer. If desired, the expert can send such content to the customer via the presentation screen. Similarly, information from the company's web site can be displayed to the customer if desired. The expert can, if desired, “hand off” control to the customer so that the customer can interact with the screen via a mouse or touch screen. A chat window allows the expert to communicate with a customer when verbal communication is either not feasible or undesired, e.g., where privacy is needed. A video escalation feature provides audio/video communication between the customer and a supervisor. This enables the expert to “hand off” the customer to a supervisor if needed or desired. A tech support live video feed permits the expert to contact technical support personnel and add them to the session. This permits the customer and technical support personnel to interact directly through their respective terminals.

The system not only permits interaction between customers and experts but permits experts to interact with each other as well. To this end, a direct show multicasting feature allows the organization's personnel to interact with each other using all-way multi-user video/audio conferencing. By using IP Multicast technology or other streaming audio/video, the system 10 is able to broadcast Audio/Visual sessions to multiple clients and thereby reduce bandwidth usage.

To facilitate and speed communication between the customer and expert, the system may split and compress the various video, audio and data signals. In particular, some of the data, such as that relating to credit cards, may be passed through the system server 24 for monitoring. The higher bandwidth video and audio signals, however, are sent and received through the peer-to-peer link established between the customer terminal and the expert terminal to minimize bottlenecks that might otherwise result from sending such information through the server. Additionally, the video and audio streams can be processed for special effects whereby voices can be enhanced or changed, and video can be converted to animation, to achieve lower bandwidth throughput.

To further enhance effective real-time communication between the customer and expert, certain information, such as that relating to specific products, can be stored locally at the customer terminal and the expert terminal respectively. The expert can then present information to the customer by sending a command to the customer terminal to display the locally stored screen or information. Similarly, the customer can launch data stored locally at the expert terminal by sending a command. Sending commands to launch locally stored data is faster and more efficient than sending the data directly from terminal to terminal or retrieving it from a server.

Effective customer service can be further enhanced by making more than one expert available to assist a customer. For example, if the customer has questions an expert cannot answer, or requests information or skills beyond those possessed by the expert; the system can allow one or more additional experts to join the session. Multi-way audio, video and data communications among the two or more experts and the customer may be established to permit the customer to get the desired assistance in an efficient manner.

In another embodiment, the expert and/or customer are each provided with the ability to control the camera 34 associated with the customer terminal. This enables the customer to zoom in on matters to be emphasized. Alternatively, the expert can zoom in on matters of interest. A similar zoom function can be provided with respect to text, images or other data appearing on the customer terminal screen to facilitate communications between the customer and expert.

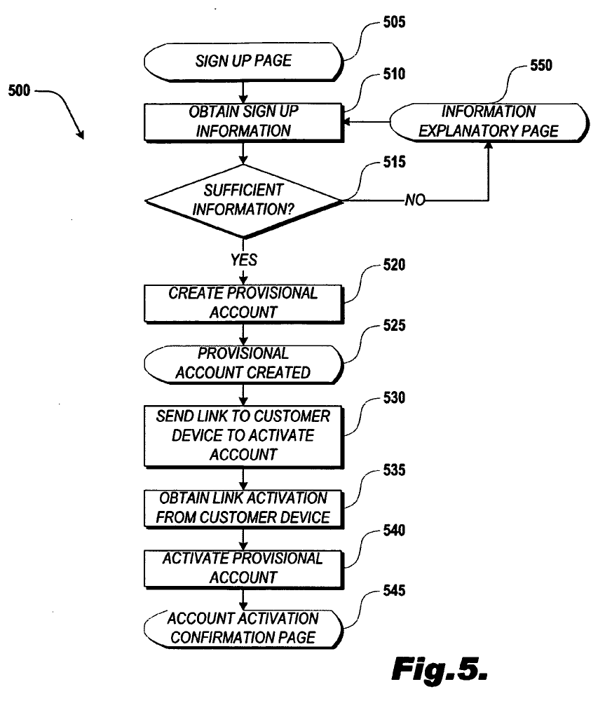

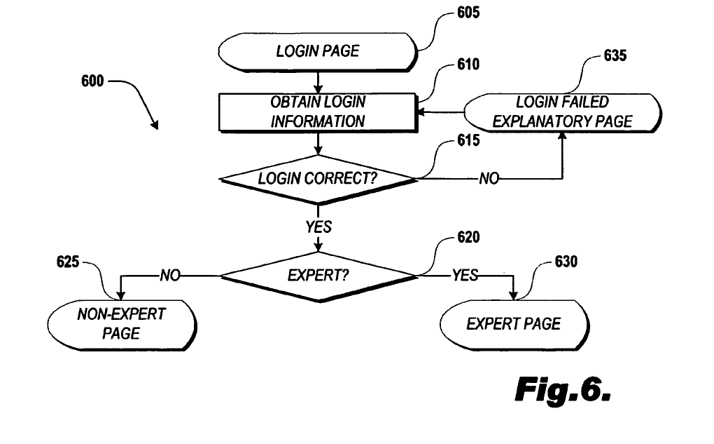

In still another embodiment, the system further includes a skill-base routing feature that facilitates connecting customers with the experts best able to serve the customer's needs. In such a system, the system router first responds to the customer's request for assistance by requesting the customer to supply information about the customer's needs. For example, the customer might be asking about products in general, about a specific product in particular or about the suitability of a product for a particular task. On the other hand, the customer might require assistance with a product already purchased. Alternatively, the customer might have questions about previous billing and payments or other matters. Depending on the customers needs, the system 10 would not simply connect the customer with the next available expert, but can determine the type of expert most suitable to the customer's needs and await the availability of an expert with the needed experience and skills. To implement this feature, the system stores information regarding the particular skill sets possessed by each expert. For example, several skill categories can be created and an expert's skill level within each category can be indicated, for example, with a “1 to 5” value. When a customer directly or indirectly indicates a need for particular skills, the system 10 uses the previously acquired and stored expert skills to match the customer 16 with an appropriate expert 18. Alternately, the customer may use an expert portal as described below with regard to FIGS. 5-23.

Similarly, the system 10 can be configured to monitor how long a customer has been waiting and direct available experts to customers on that basis so that no customer is left waiting an inordinate amount of time. Additionally, the system can allocate resources based on the number of customers waiting for assistance. This can be useful, for example, where a number of customers are waiting to pay for their purchases, but only a few checkout personnel are present on the premises to accept payment and complete the transaction. By making off-site checkout experts available through the live, on-screen video expert system 10, the customers can make their payments and be on their way quicker than if they had to wait for a checkout line to move forward.

The live, on-screen video expert system 10 provides many benefits over maintaining a live service staff physically present at each store location. Among these benefits is that the customers and the experts need not be in the same facility, or even in the same city or country. It is possible, therefore, for a business with outlets throughout the country or the world, to have a centralized service staff that can assist customers anywhere. Similarly, because business peaks are likely to occur sequentially at different times in different parts of the country, a single centralized service staff is available to assist customers, for example, first on the East Coast, then the Midwest, then finally the West Coast during respective business peaks over the Noon hour in each region. Similarly, experts having specialized experience and expertise can be made available to customers throughout the country or world, without having to maintain such experts at each store location. The system, therefore, makes it practical to maintain a small staff of experts able to provide their expertise wherever needed regardless of their actual physical location. It will be appreciated that the various specific examples shown and described herein are meant to illustrate and exemplify the types of capabilities that can be provided and achieved by the live, on-screen video expert system and, as such, are meant to be illustrative rather than limiting.

In a further enhancement to a system for providing experts, the system server 24 (or one or more additional device not shown) may include an expert “portal” capability such that customers may search for experts in a variety of areas. FIGS. 5-23 illustrate a simplified representation of an exemplary operation of such an expert portal where customers can go to obtain expert assistance from online experts.

FIG. 5 illustrates an exemplary flow diagram for processing a customer sign-up. Customer sign-up routine 500 begins at block 505 where a customer is presented with a sign-up page. Next, in block 510, sign-up information is obtained for the customer (e.g., by the customer completing form fields within the sign-up page). In decision block 515, a determination is made whether there is sufficient customer sign-up information. If so, processing continues to block 520. If, however, in decision block 515 it was determined that more information is needed, processing proceeds to block 550 where the customer is presented with an explanatory page describing what additional information is needed. Processing returns back to block 510.

In block 520, a provisional account is created for the customer using the provided customer information. A page indicating of the provisional account has been created is displayed at block 525. In block 530, a link is sent to the customer whereby the customer may activate their provisional account. Although a number of different communication channels may be used to send the link to the customer, in one embodiment an electronic message, e.g., SMS, e-mail, MMS or the like is sent to the customer with a hypertext link to a remote web page. In block 535, hypertext link activation is obtained from the customer's device and the provisional account is activated in block 540. The customer is then presented with an account activation confirmation page at block 545.

Once a customer (or an expert as in some embodiments experts may also be customers) has signed up, the customer may log in to their account. FIG. 6 illustrates an exemplary login routine 600. Login routine 600 begins by presenting a customer with a login page in block 605. In block 610, login information is obtained from the customer. Next, in block 615, a determination is made whether the login information is correct. If for some reason the login information was incorrect, processing proceeds to block 635 where a page is displayed explaining that the login failed to the customer. Processing returns back to block 610.

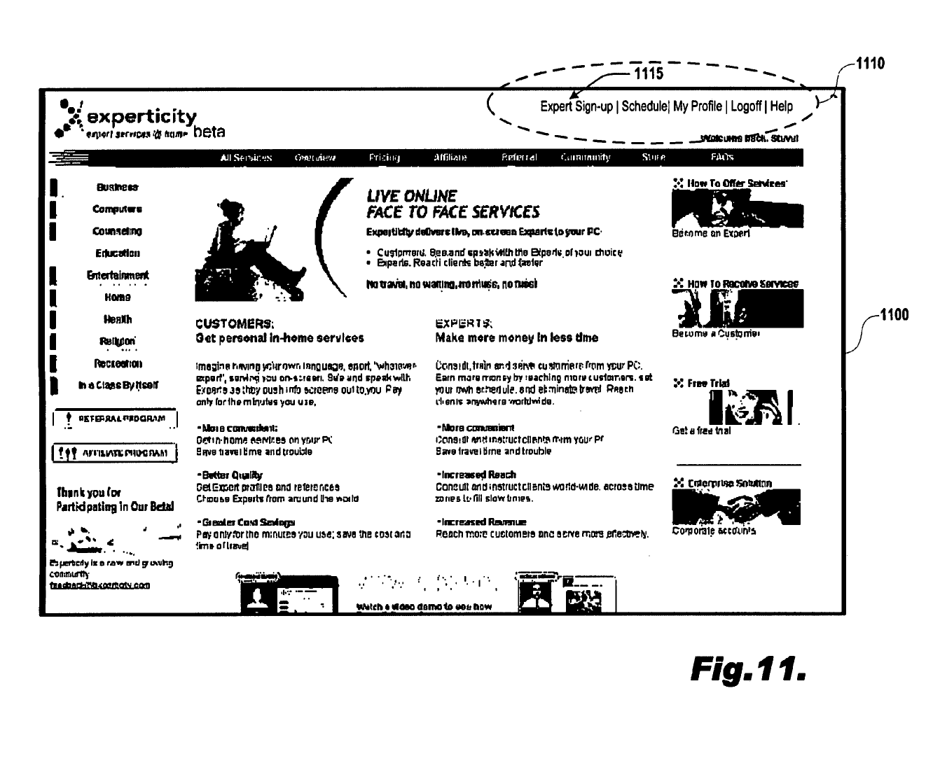

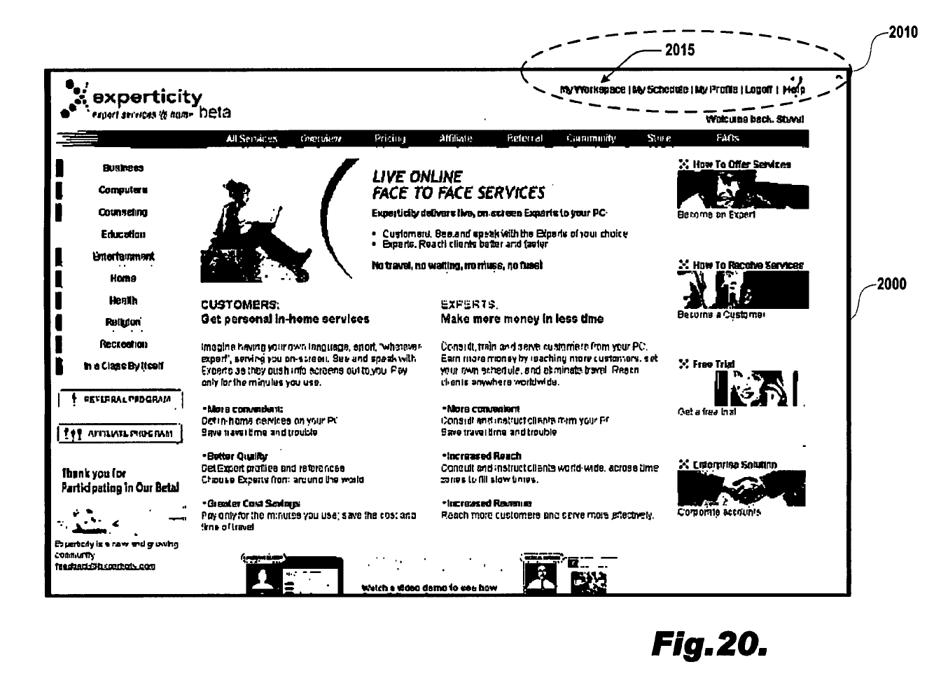

If, however, in decision block 615 it was determined that the login information is correct, processing proceeds to block 620 where determination is made whether the customer that has just logged in is also an expert. If so, the customer is presented with an expert page at block 630. An exemplary expert page 2000 is shown in FIG. 20 and described below. Likewise if in decision block 620 it was determined that the customer is not an expert, a non-expert customer page is presented at block 625. An exemplary non-expert customer page 1100 is illustrated in FIG. 11 and described below.

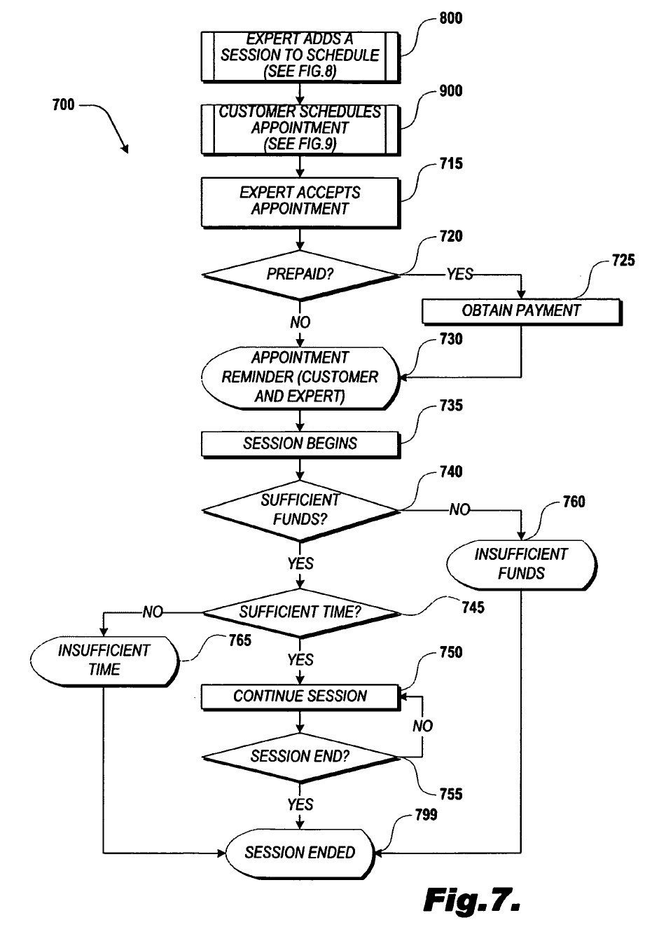

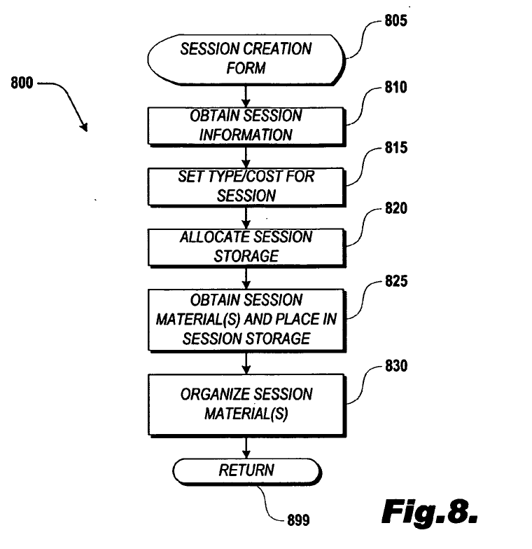

Once a customer 16 or expert 18 has signed into the expert portal, there are a number of supported activities that they may engage in. Generally, customers may look for experts to communicate with and experts may prepare their communications materials and manage their presentations and sessions for customers. FIG. 7 illustrates a series of activities within an expert portal system for a customer to be able to communicate with an expert during an expert session. Accordingly, portal activity routine 700 begins at subroutine block 800 where an expert adds a session to their schedule. Subroutine block 800 is illustrated in FIG. 8 and described below.

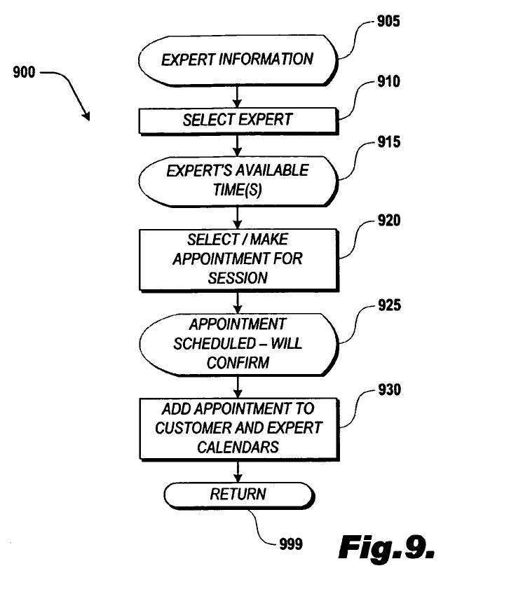

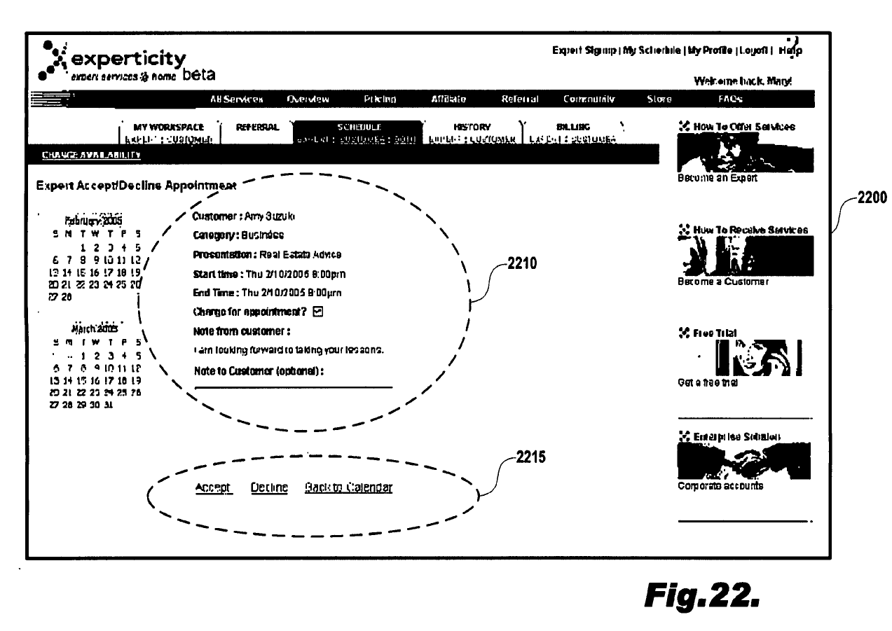

Next, in subroutine block 900, a customer schedules an appointment with the expert. Subroutine block 900 is illustrated in FIG. 9 and described below. Next, in block 715, the expert 18 accepts the appointment requested by the customer 16. FIG. 22 illustrates an exemplary screen shot 2200 of an expert acceptance web page.

Routine 700 continues to block decision block 720 where determination is made whether the expert session is a prepaid session requiring a customer to pay for the session before the session begins. If so, processing proceeds to block 725 where prepayment has obtained (e.g., via credit cards, on-line payments, a customer's prepaid account, or the like).

After obtaining payment, or if the session does not require prepayment processing proceeds to block 730 where an appointment reminder for both the customer and expert is displayed.

In some embodiments, the customer 16, the expert 18, or both may have an additional computing application on their respective devices that can Interact with the system server 24 to keep an up-to-date schedule of appointed sessions. In alternate embodiments, a customer and/or expert schedule may be presented in an on-line calendar format without a specific scheduling application on the customer and/or expert's device. Routine 700 continues to block 735, where the session between the customer and expert begins. Periodically, the system server 24 may check if there are sufficient funds to keep the current session active. Accordingly, in decision block 740, a determination is made whether there are sufficient funds. If so, processing proceeds to decision block 745, where there is an additional check to see if there is sufficient time remaining in the session. If there is both sufficient funds and sufficient time, the session continues, possibly with additional funds and/or time checks. In decision block 755, a determination was made whether the session should end (e.g., either the customer and/or the expert had indicated that this session should end or the session has been pre-designated that it will end upon meeting certain conditions, such as a period of time, use of funds or upon some other predetermined criteria). If so, processing proceeds to block 799, where the session ends and the customer and/or expert is presented with a session ended page. Returning back to decision block 740, if it was determined that there are insufficient funds, the customer and/or expert receive an indication that there are insufficient funds in block 760. After which, processing proceeds to block 799.

Similarly, in decision block 745, if it was determined that there is insufficient time, the customer and/or expert receive an indication in block 765 that there is insufficient time for the session to continue and processing proceeds to block 799.

The above description of an expert session is a simplified representation of one such embodiment. In alternate embodiments, further interactions and options may be possible. For example, customers may be allowed to pay for additional time and/or sessions instead of the session ending. Likewise, the expert may extend the period of time granted to a customer if they are willing to do so.

FIG. 8 illustrates an exemplary session creation routine 800, where an expert creates a session for use with customers. Session creation routine 800 begins at block 805 where a session creation form is presented to the expert. In block 810, session information is obtained from the expert 18. In block 815, the type and cost of the session is set by the expert 18. In block 820, storage for session materials is allocated by the expert 18. In some embodiments, experts may be charged the fee for the use of the export portal system's resources (e.g., for use of communication connections, computing devices and/or storage systems). Some examples of fees may include fees for periodic time charges, bandwidth usage, storage quotas and the like.

In block 825, session materials are obtained and placed in storage. Exemplary session materials may include multimedia information such as videos, images, sound files, textual information and the like which is prepared to be shared with a customer or customers during a session with the expert 18. In block 830, the session materials may be organized such that the expert 18 can have access to them in an efficient manner during their session with a customer 60. In block 899 subroutine 800 ends and returns to its calling routine.

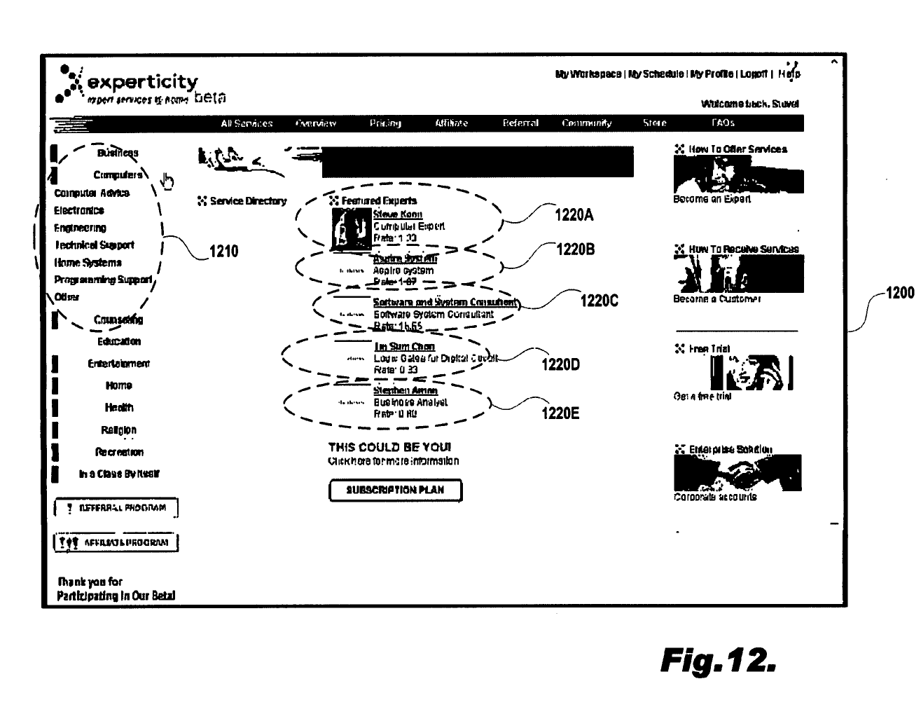

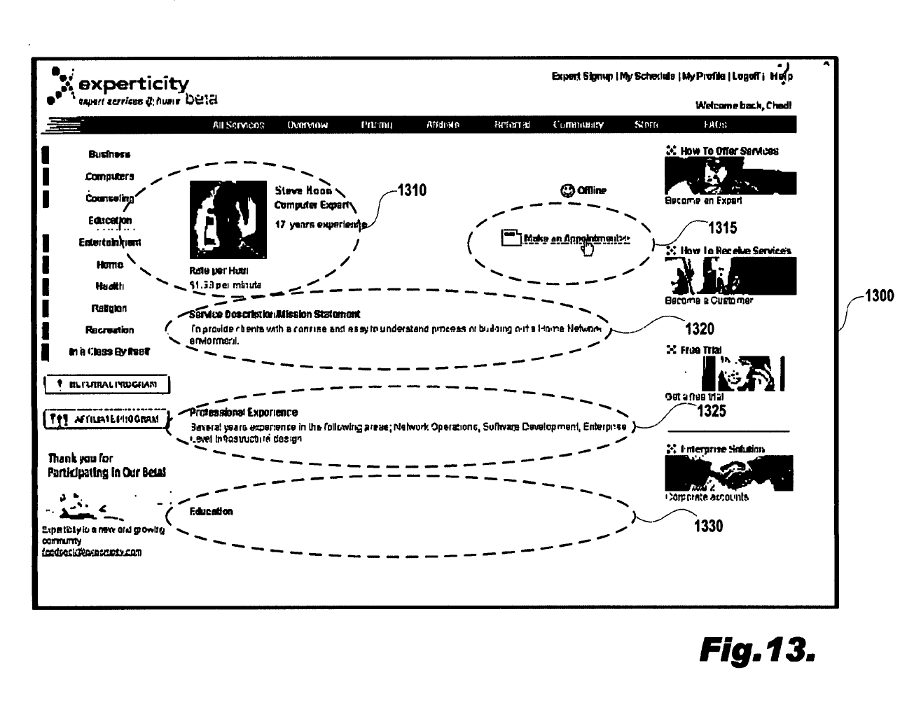

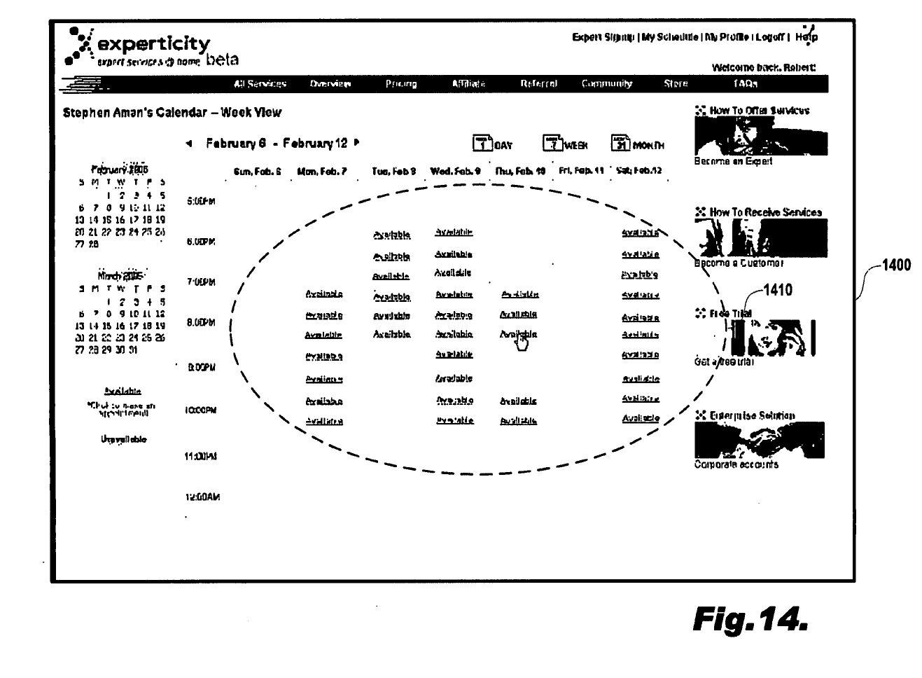

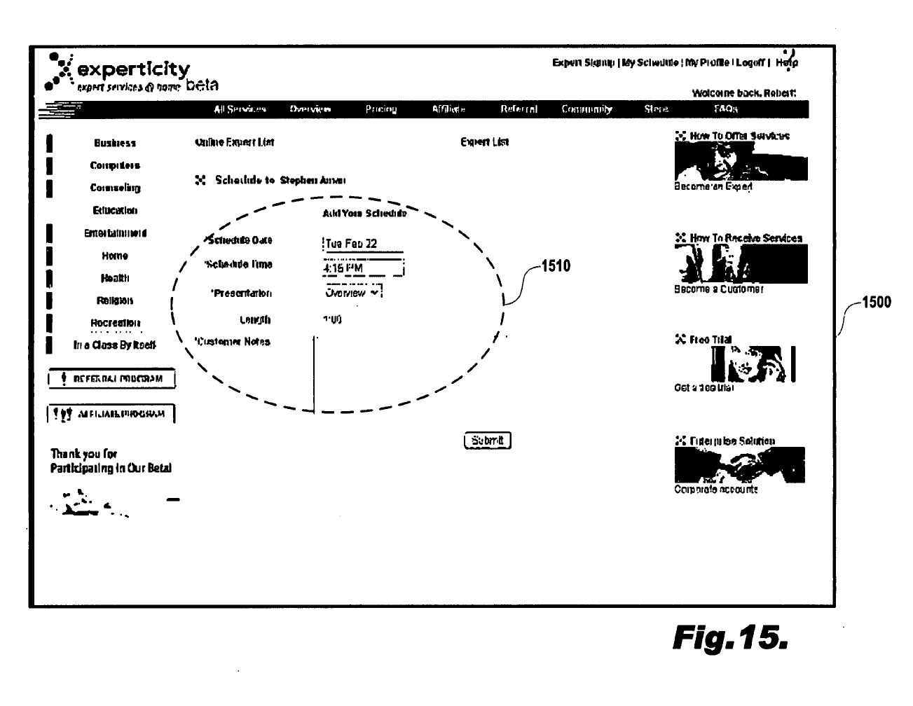

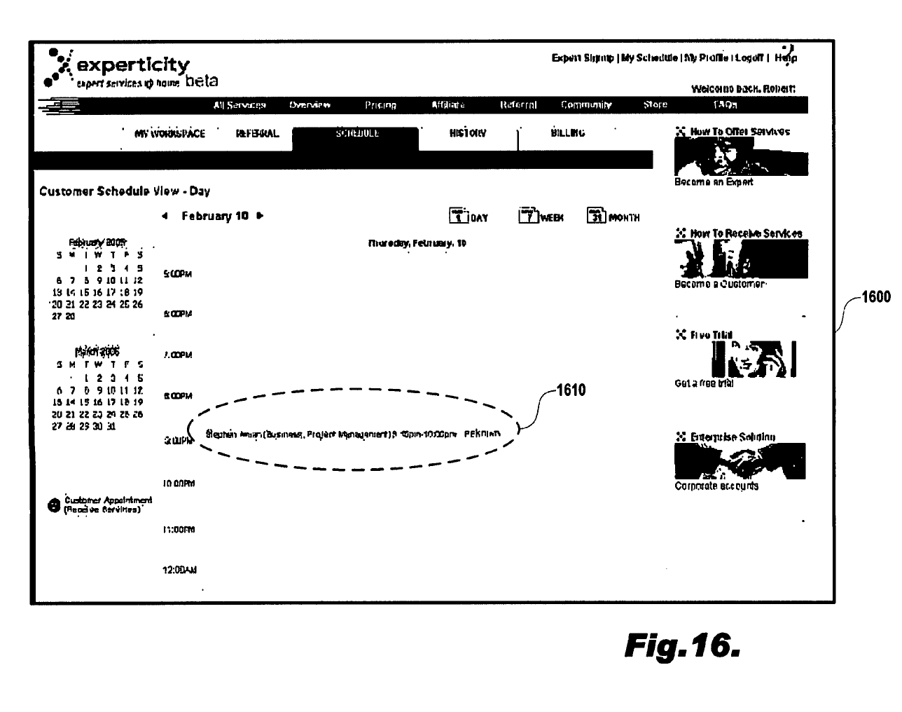

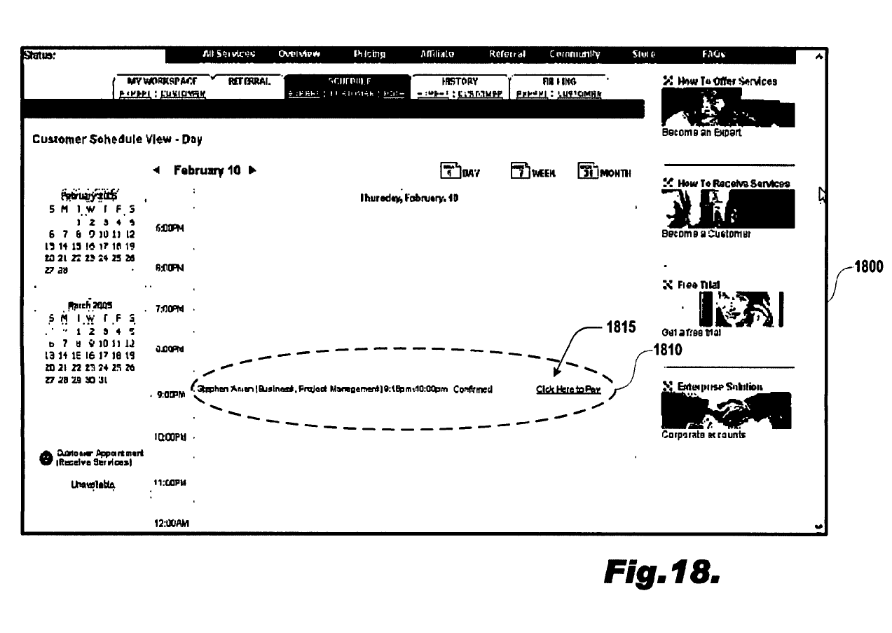

FIG. 9 illustrates an exemplary session appointment scheduling subroutine 900. Session in scheduling subroutine 900 begins at block 905 where a customer is presented with expert information. FIG. 12 illustrates an exemplary expert information screen shot 1200, which is further described below. In block 910, a customer 16 selects an expert 18 with him to schedule a session. FIG. 13 illustrates an exemplary selected expert screen shot 1300, which is described in further detail below. In block 915, the experts' available times for appointments are displayed. FIG. 14 illustrates an exemplary expert schedule screen shot 1400, which is described in further detail below. In block 920, the customer 16 selects an appointment from the expert's available times for a session. FIG. 15 illustrates an exemplary appointment time selection screen shot 1500, which is further described below. The appointment is scheduled for the customer 16, and in block 925, they are notified that the appointment is scheduled and pending. The pending appointment is added to both the customer's and the expert's calendar. FIG. 16 illustrates an exemplary customer calendar screen shot 1600, which is described in further detail below. Subroutine 900 continues to block 999 where subroutine 900 returns to its calling routine. Note that once an expert accepts the requested appointment, its status would change from “pending” to “confirmed.” FIG. 18 illustrates an exemplary customer calendar screen shot 1800 where a customer's requested appointment has been accepted by an expert 18 and is therefore confirmed.

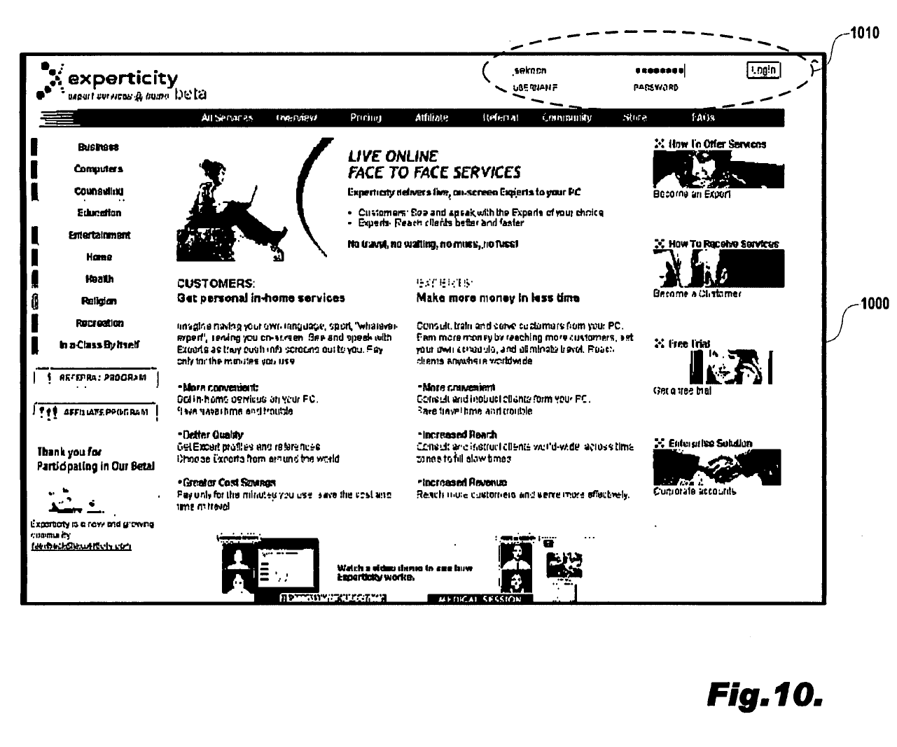

FIGS. 10-19 illustrate exemplary customer screen shots 1000-1900 illustrating exemplary actions by customers within the expert portal system. FIG. 10 is an exemplary sign-in screen shot 1000 where a customer presents login Information 1010 (e.g., username and password).

FIG. 11 illustrates an exemplary main page 1100 shown to a customer who has signed in. Note the customer links 1110 that include an option for the customer to sign up as an expert 1115. The expert sign-up process would be similar to the conventional customer sign-up; however, there may be additional questions relating to the type of expertise that a customer would be willing to provide as an expert.

FIG. 12 illustrates an exemplary expert browsing/selection screen shot 1200 where a number of experts' bios 1220A-E are presented from within an expert category 1210. A customer 16 would be able to select an expert bio to obtain further information about an expert 18.

FIG. 13 illustrates an exemplary expanded biography screen shot 1200 for a particular expert 18. The expanded expert biography may include the name, experience, references, certifications, reputation and the rate of the expert 1310, a link to make an appointment 1315, a service description 1320, a description of professional experience 1325, education information 1330 and the like. Assuming a customer selects a link to make an appointment with an expert 18, they may be presented with an expert schedule screen shot such as screen shot 1400 illustrated in FIG. 14. Screen shot 1400 presents a schedule 1410 of available times that a customer 16 can select to have a session with an expert 18.

Upon selecting an available schedule time, a customer 16 may be presented with a screen shot 1500 such as the one illustrated in FIG. 15 giving detailed information as to an appointment with the expert 1510.

FIG. 16 illustrates an exemplary schedule screen shot 1600 showing a customer schedule, including a pending appointment 1610 for a requested session with an expert 18.

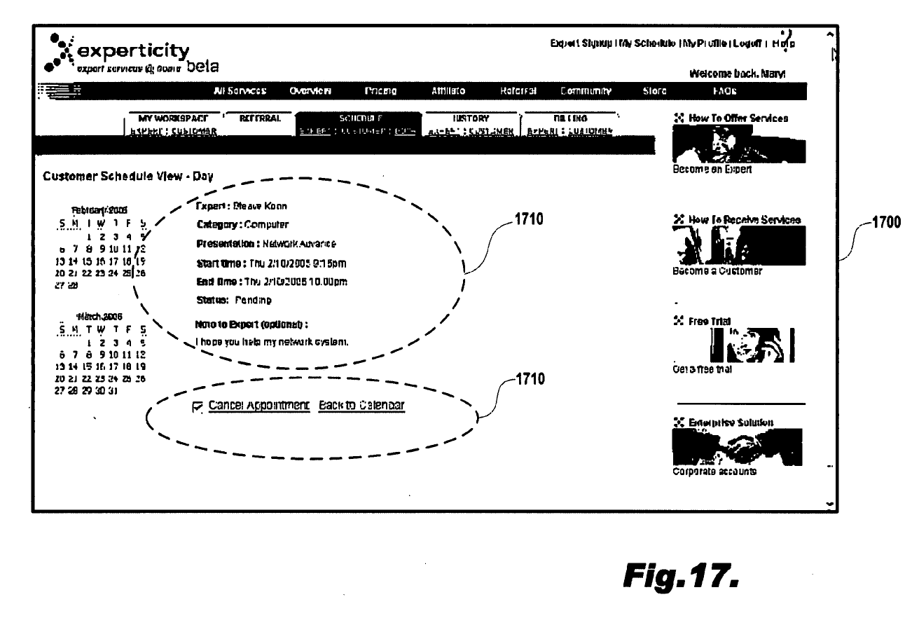

FIG. 17 illustrates a detailed appointment screen shot 1700 showing detailed information 1710 about the session appointment and also including links to additional actions with regard to the appointment (e.g., cancelling the appointment, rescheduling the appointment or the like).

FIG. 18 illustrates an exemplary customer calendar screen shot 1800 that also includes a confirmed appointment 1810 with a payment link 1815 to allow a customer to pay for a scheduled session with an expert 18.

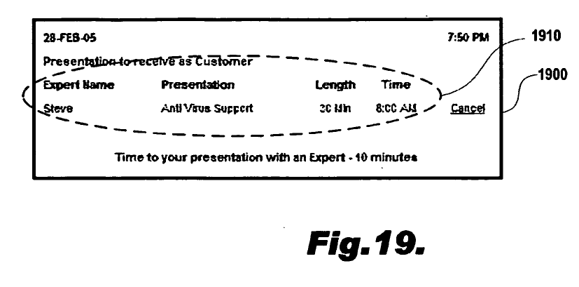

FIG. 19 illustrates a reminder screen shot 1900 that includes an appointment reminder 1910 for an upcoming session with an expert 18. The appointment reminder screen shot 1900 may be presented as part of a web page, active content within a web page, or within a separate application installed on the customer's device 14.

FIGS. 20-23 illustrate exemplary expert screen shots 2000-2300. FIG. 20 illustrates an exemplary expert login page 2000 that includes expert login or expert options for an expert that has logged into the expert portal option. Included in the expert options 1910 is a “my workspace” option 1915 that allows an expert to access their session workspace area.

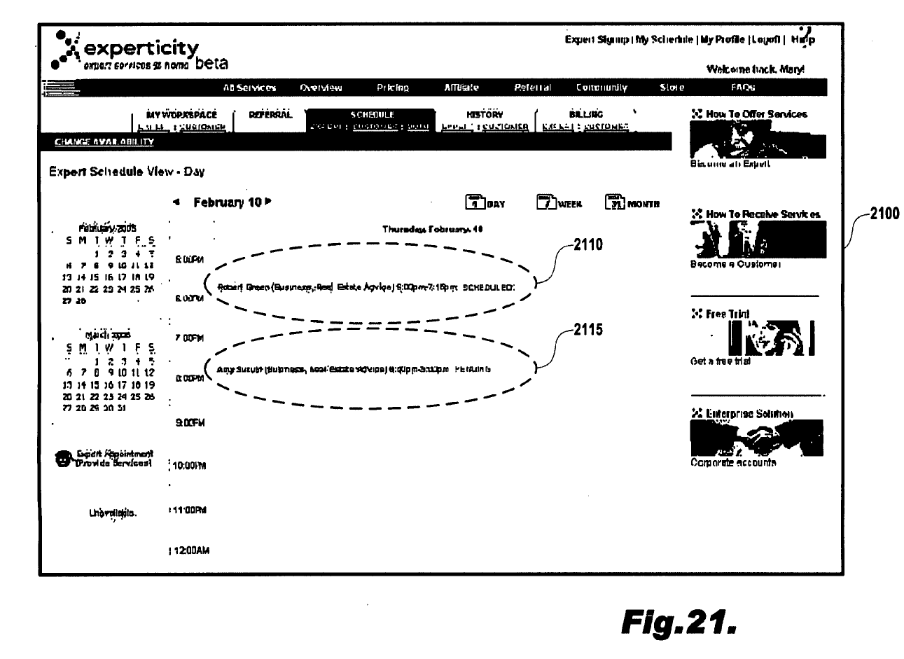

FIG. 21 illustrates an exemplary expert calendar screen shot 2100 included in the expert calendar are a scheduled appointment 2010 and an appointment that is still pending 2015 (i.e. they have yet to confirm with the customer 16).

FIG. 22 illustrates an exemplary appointment confirmation screen shot 2200 including appointment details 2210 and options to act on the appointment 2115 (e.g., accept, decline, etc.).

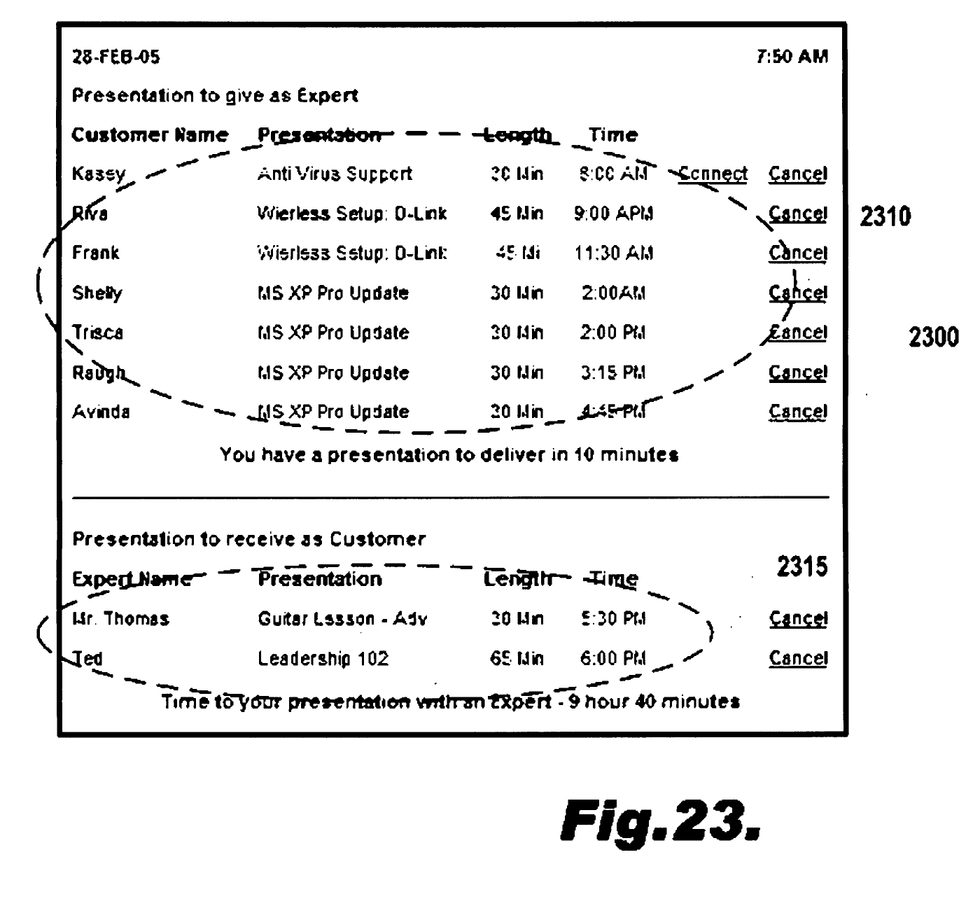

FIG. 23 illustrates an exemplary expert schedule screen shot 2300 including reminders and schedules for presentation sessions 2310 and sessions where the expert is acting as a customer 2315.

In further embodiments, one or more experts may communicate with a plurality of customers during a session. In such multiple customer embodiment, multi-cast devices and related technologies may be used to broadcast the expert's session. In some such embodiments, additional devices (not shown) may be used in the expert system 10. However, in some embodiments, the system server and/or client server 26 may include multi-cast or reflector capabilities.

Likewise, while in some embodiments, the system server 24 may provide portal functionality for searching for experts within the expert system 10; in alternate embodiments, one or more portal servers (not shown) may provide expert searching a connections capabilities for the expert system 10.

While exemplary embodiments have been shown and described, it will be apparent to those skilled in the art that changes and modifications can be made without departing from the invention in its broader aspects, and, therefore, the aim in the appended claims is to cover all such changes and modifications as fall within the spirit and scope of the invention.

What is claimed is:

1. A system for providing real-time interaction between a human customer and a human expert in a commercial transaction setting wherein the human customer and human expert are not in each other's physical presence, comprising:
a customer terminal operable to transmit and receive video, audio and data communications;
an expert terminal operable to transmit and receive video, audio and data communications; and
a network for establishing a peer-to-peer connection between said customer terminal and said expert terminal so that video, audio and data information can be passed in real-time between the customer and the expert through said customer terminal and said expert terminal.

2. A system as defined in claim 1 further comprising a database containing information relevant to the commercial transaction and structure providing connectivity between said database and said expert terminal.

3. A system as defined in claim 2 wherein said database, said structure providing connectivity and said network include a system server and a client back end server coupled to each other and to said customer and said expert terminals through a peer-to-peer connection.

4. A system as defined in claim 3 wherein said customer terminal, said expert terminal, said system server and said client back end server are interconnected through a high speed network.

5. A system as defined in claim 1 wherein said system includes a plurality of said customer terminals.

6. A system as defined in claim 5 wherein said network is operable to provide peer-to-peer connectivity between said expert terminal and any one of said plurality of said customer terminals.

7. A system as defined in claim 1 wherein said customer terminal and said expert terminal each comprise a PC-based transmitting and receiving platform.

8. A system as defined in claim 7 wherein said customer terminal and said expert terminal each include a video display screen, a microphone and a speaker.

9. A system as defined in claim 8 wherein said customer terminal and said expert terminal each further include one or more peripheral devices.

10. A system as defined in claim 9 wherein said peripheral devices are selected from the group including a printer, a credit card scanner, an RFID detector, a bar code scanner and a biometric security device.

11. A system as defined in claim 1 wherein said customer terminal and said expert terminal each include associated memory for storing and retrieving information relevant to the commercial transaction.

12. A system as defined in claim 11 wherein said information includes information relating to product specifications.

13. A system as defined in claim 12 wherein said information further includes data relating to the commercial transaction itself.

14. A system as defined in claim 1 wherein said customer terminal and said expert terminal are located in physically separate locations.

15. A method of providing human interaction between a customer and a expert who are not in each other's physical presence, comprising:
providing a customer terminal operable to transmit and receive video, audio and data communications;
providing an expert terminal operable to transmit and receive video, audio and data communications; and
establishing a peer-to-peer connection between said customer terminal and said expert terminal so that video, audio and data information can be passed in real-time between the customer and the expert through the customer terminal and the expert terminal.

16. A method as defined in claim 15 further including the step of communicating between said customer terminal and said expert terminal by means of wireless communications.

17. A method as defined in claim 15 further comprising the step of passing product information to the customer terminal under control of the expert.

18. A method as defined in claim 15 wherein the peer-to-peer connection is provided by means of a high-speed network.

19. A computer-implemented method of connecting an expert device and at least one customer device not in close proximity, the method comprising:
obtaining at least one set of customer contact information;
obtaining expert contact information;
depicting a connection user interface component;
upon determining that a connection should begin, providing at least one of said at least one set of customer contact information and expert contact information to a session application operative to establish a connection between the expert device and at least one customer device.

20. The method of claim 19, further comprising obtaining connection timing information.
